(19) United States
(12) Patent Application Publication
(10) Pub. No.: US 2013/0040482 A1
(43) Pub. Date: Feb. 14, 2013

(54) ELECTRICAL CONNECTOR WITH SIDE-MOUNTED LATCH

(71) Applicants: Hung Viet Ngo, Austin, TX (US); Christopher Gieski, Dillsburg, PA (US); Christopher J. Kolivoski, Lewisberry, PA (US)

(72) Inventors: Hung Viet Ngo, Austin, TX (US); Christopher Gieski, Dillsburg, PA (US); Christopher J. Kolivoski, Lewisberry, PA (US)

(21) Appl. No.: 13/571,697

(22) Filed: Aug. 10, 2012

Related U.S. Application Data
(60) Provisional application No. 61/523,049, filed on Aug. 12, 2011.
(60) Provisional application No. 61/643,109, filed on May 4, 2012.

(51) Int. Cl. H01R 13/62

(52) U.S. Cl. 439/328

(57) ABSTRACT

An electrical connector may retain a substrate in secure, mating engagement with the electrical connector. The electrical connector can include at least one attachment member that is configured to engage a side of the substrate so as to attach the electrical connector to the substrate when the electrical connector is mated with the substrate.

### CROSS-REFERENCE TO RELATED APPLICATIONS

This claims the benefit of U.S. Patent Application Ser. No. 61/523,049, filed Aug. 12, 2011, and further claims the benefit of U.S. Patent Application Ser. No. 61/643,109, filed May 4, 2012, the disclosure of each of which is hereby incorporated by reference as if set forth in its entirety herein.

### BACKGROUND

Receptacle style electrical connectors can be configured to be mated with a complementary electrical component, such as a substrate. Typically, a substrate carries a plurality of electrical contact pads along opposed sides of an edge of the substrate. The electrical connector can carry a plurality of electrical contacts configured to abut the electrical contact pads on the substrate when the electrical connector is mated to the substrate, thereby placing the electrical connector into electrical communication with the substrate. Although the electrical contact pads on a substrate can be received between resilient mating ends of the electrical contacts carried by the electrical connector, it may nevertheless be desirable to provide additional mechanisms for securing and/or maintaining mating engagement between the receptacle connector and the substrate.

### SUMMARY

In accordance with one embodiment, an electrical cable is connector configured to be mated to a substrate along a mating direction. The electrical connector can include a connector housing that defines a housing body that has a front end that defines a mating interface. The housing can further define a receptacle that extends into the front end so as to at least partially define the mating interface, the receptacle sized to receive a front edge of the substrate. The electrical connector further includes a plurality of electrical contacts carried by the connector housing, the electrical contacts defining mating ends that are configured to electrically connect to electrical contact pads carried by at least one of top and bottom surfaces of the substrate when the mating interface receives the substrate. The electrical contacts define mounting ends that are disposed opposite the mating ends and are configured to electrically connect to respective cables. The electrical connector further includes at least one latch member supported by the connector housing. The at least one latch member can include 1) a latch body that includes a latch arm that extends forward from the front end of the housing body, and a lock member that extends from the latch arm and is spaced forward from the front end of the housing body along the mating direction, the lock member defining a leading engagement surface and a trailing engagement surface, and 2) a spring member.

The leading engagement surface can be configured to be aligned with a leading engagement surface of an attachment member of the substrate as the electrical connector is mated to the substrate, such that the leading engagement surface of the lock member is configured to move in a perpendicular to the mating direction against a biasing force of the spring member until the trailing engagement surface moves past a trailing engagement surface of the attachment member of the substrate, such that the biasing force of the spring member drives the latch body to move in an attachment direction so as to bring the trailing engagement surfaces into alignment with respect to the mating direction.

### BRIEF DESCRIPTION OF THE DRAWINGS

The foregoing summary, as well as the following detailed description of the preferred embodiments of the application, will be better understood when read in conjunction with the appended drawings. For the purposes of illustrating the latching electrical connector, there are shown in the drawings preferred embodiments. It should be understood, however, that the instant application is not limited to the precise arrangements and/or instrumentalities illustrated in the drawings, in which:

FIG. 1A is a perspective view of an electrical connector assembly that includes a substrate, a cable assembly, and an electrical connector that is configured to be mounted to the cable assembly and mated to the substrate in accordance with an embodiment;

FIG. 1B is an exploded perspective view of the electrical connector assembly, showing the substrate exploded from the electrical connector;

FIG. 2A is a perspective view of a power contact assembly of the electrical connector illustrated in FIG. 1;

FIG. 2B is a perspective view of a portion of the power contact assembly illustrated in FIG. 2A;

FIG. 2C is a perspective view of a signal contact assembly of the electrical connector illustrated in FIG. 1;

FIG. 2D is a perspective view of a portion of the signal contact assembly illustrated in FIG. 2C;

FIG. 3 is a perspective view of the substrate illustrated in FIG. 1;

FIG. 4A is a perspective view showing the substrate aligned with the electrical connector for mating;

FIG. 4B is a top perspective view showing the latch member of the electrical connector during attachment to the substrate as the electrical connector is mated with the substrate;

FIG. 4C is a bottom perspective view showing the latch member attached to the substrate after the electrical connector has been mated with the substrate;

FIG. 5A is a perspective view of a substrate of the electrical connector assembly illustrated in FIG. 1, constructed in accordance with an alternative embodiment;

FIG. 5B is a top perspective view showing the latch member of the electrical connector of the electrical connector assembly illustrated in FIG. 1, but constructed in accordance with an alternative embodiment, during attachment to the substrate illustrated in FIG. 5A as the electrical connector is mated with the substrate; and

FIG. 5C is a perspective view showing a latch member constructed in accordance with an alternative embodiment.

### DETAILED DESCRIPTION

For convenience, the same or equivalent elements in the various embodiments illustrated in the drawings have been identified with the same reference numerals. Certain terminology is used in the following description for convenience only and is not limiting. The words “left”, “right”, “front”, “rear”, “upper,” and “lower” designate directions in the drawings to which reference is made. The words “forward”, “forwardly”, “rearward”, “inner,” “inward,” “inwardly,” “outer,” “outward,” “outwardly,” “upward,” “upwardly,” “downward,” and “downwardly” refer to directions toward and away from, respectively, the geometric center of the object referred to and designated parts thereof. The terminology intended to be non-limiting includes the above-listed words, derivatives thereof and words of similar import.

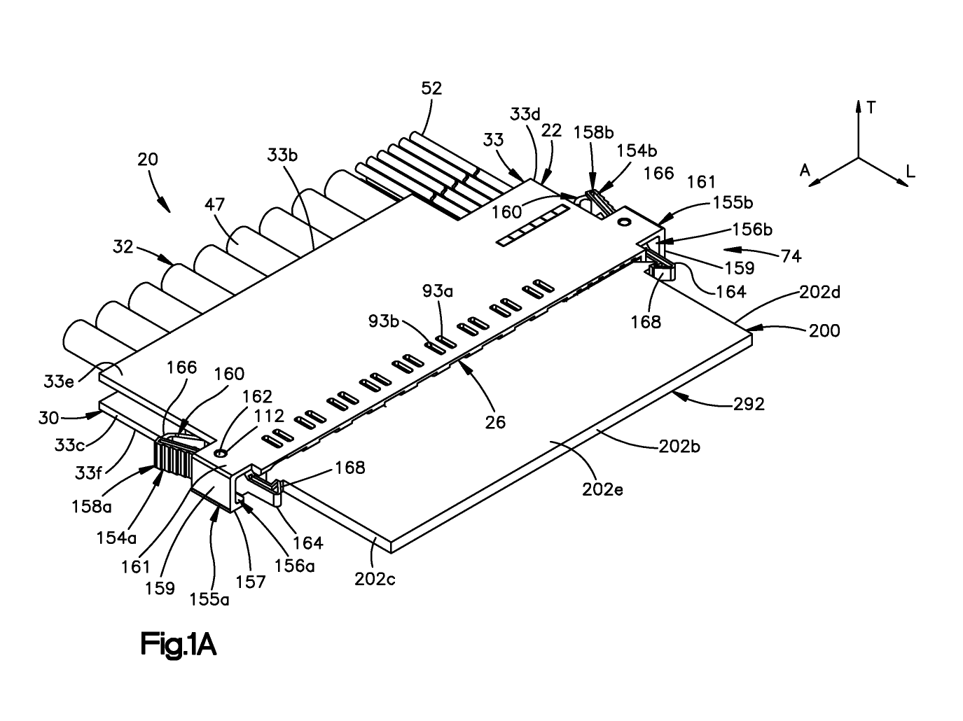

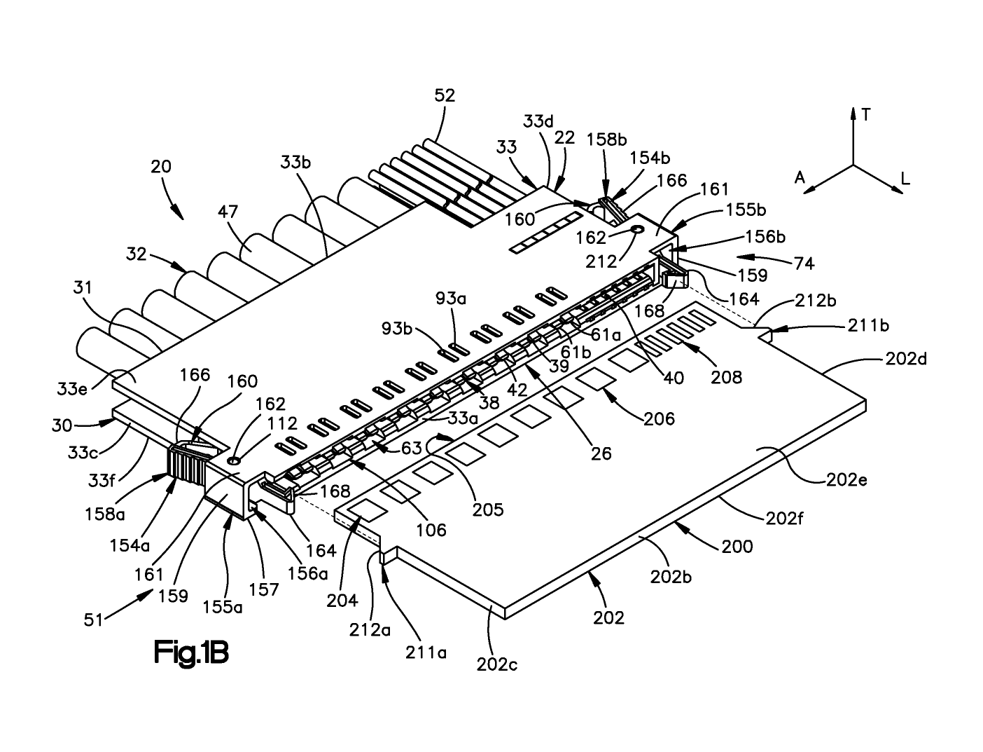

Referring initially to FIGS. 1A-B, in accordance with one embodiment, an electrical connector assembly 20 includes an electrical connector 22 that is configured to be mated to a complementary electrical component in the form of a substrate 200, which can be configured as a printed circuit board in accordance with the illustrated embodiment. In accordance with the illustrated embodiment, the electrical connector 22 is configured as an electrical cable connector. The electrical connector 22 includes a dielectric or electrically insulative connector housing 30 and a plurality of electrical contacts 38 that are supported by the connector housing 30. The electrical connector 22 defines a mounting interface 31 that is configured to be mounted onto the cable assembly 32, thereby placing the plurality of electrical contacts 38 in electrical communication with the cable assembly 32.

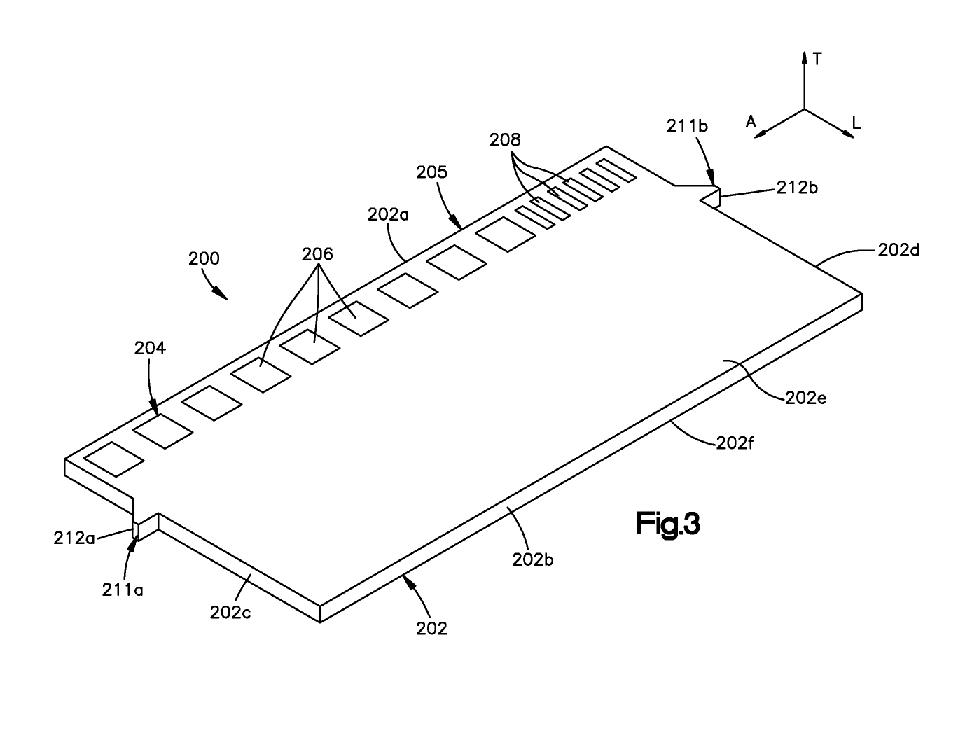

The electrical connector 22 further defines a mating interface 26. The electrical connector 22 is configured to mate with the substrate 200, thereby placing the plurality of electrical contacts 38 in electrical communication with electrical contact pads 204 of the substrate 200 (see FIG. 3), and electrical traces that are carried by the substrate 200. As will be described in more detail below, the electrical connector assembly 20 can include an attachment assembly 74, which can be configured as a latch assembly. For instance, the electrical connector 22 can include at least one attachment member such as a first attachment member 154a and a second attachment member 154b that are supported by the connector housing 22. The substrate 200 can similarly include at least one attachment member such as a first attachment member 211a and a second attachment member 211b. Thus, the attachment assembly 74 can include the first and second attachment members 154a-b of the electrical connector 22, and the first and second attachment members 211a-b of the substrate 200. The first and second attachment members 154a-b are configured to mate with the first and second attachment members 211a-b, so as to secure the substrate 200 to the electrical connector 22 when the electrical connector 22 is mated with the substrate 200 as illustrated in FIG. 1A.

Various structures are described herein as extending horizontally along a longitudinal direction “L” and lateral direction “A” that is substantially perpendicular to the longitudinal direction L, and vertically along a transverse direction “T” that is substantially perpendicular to the longitudinal and lateral directions L and A, respectively. As illustrated, the longitudinal direction “L” extends along a forward/rearward direction of the electrical connector assembly 20, and defines a mating direction M along which one or both of the first and second electrical connectors 22 and 24 are moved relative to the other so as to mate with the other electrical connector. For instance the mating direction M of the electrical connector 22 is a forward direction along the longitudinal direction L. The lateral direction “A” extends along a width of each of the first and second electrical connectors 22 and 24, respectively, and the transverse direction “T” extends along a height of each of the first and second electrical connectors 22 and 24. Thus, unless otherwise specified herein, the terms “lateral,” “longitudinal,” and “transverse” are used to describe the orthogonal directional components of various components. The terms “inboard” and “inner,” and “outboard” and “outer” and like terms when used with respect to a specified directional component are intended to refer to directions along the directional component toward and away from the center of the apparatus being described.

It should be appreciated that while the longitudinal and lateral directions are illustrated as extending along a horizontal plane, and that the transverse direction is illustrated as extending along a vertical plane, the planes that encompass the various directions may differ during use, depending, for instance, on the orientation of the various components. Accordingly, the directional terms “vertical” and “horizontal” are used to describe the electrical connector assembly 20 and its components as illustrated merely for the purposes of clarity and convenience, it being appreciated that these orientations may change during use.

The connector housing 30 includes a housing body 33 that defines a front end 33a and an opposed rear end 33b spaced from the front end 33a along the longitudinal direction L, first and second opposed sides 33c and 33d, which can define outermost sides of the housing body 33, that are spaced from each other along the lateral direction A, and a top end 33e and an opposed bottom end 33f that is spaced from the top end 33e along the transverse direction T. The front end 33a of the housing body 33 can define the mating interface 26 of the electrical connector 22, and the rear end 33b can define the mounting interface 31 of the electrical connector 22. Accordingly, the mating interface 26 and the mounting interface 31 are oriented substantially parallel to each other in accordance with the illustrated embodiment, and the electrical connector 22 can be referred to as a vertical electrical connector. It should be appreciated, however, that the electrical connector can alternatively be a right-angle connector, whereby the mating interface 26 and the mounting interface 31 are oriented substantially perpendicular to each other.

With continuing reference to FIGS. 1A-B, the plurality of electrical contacts 38 can include at least one electrical signal contact 40 such as a plurality of electrical signal contacts 40, and at least one electrical power contact 42 such as a plurality of electrical power contacts 42. In accordance with the illustrated embodiment, the electrical power contacts 42 are disposed adjacent the first side 33c, and the electrical signal contacts 40 are disposed adjacent the second side 33d. Accordingly, the electrical signal contacts 40 can be disposed between the electrical power contacts 42 and the second side 33d, and the electrical power contacts 42 can be disposed between the electrical signal contacts 40 and the first side 33c. In accordance with alternative embodiments, the electrical connector can be devoid of electrical signal contacts 40, such that the plurality of electrical contacts 38 includes only electrical power contacts 42. Alternatively still, the electrical connector 22 can be devoid of electrical power contacts 42, such that the plurality of electrical contacts 38 includes only electrical signal contacts 40.

The plurality of electrical contacts 38 can define mating ends 39 that are configured to mate with the electrical contact pads 204 of the substrate so as to mate the electrical connector 22 with the substrate. The mating ends 39 of the plurality of electrical contacts 38 can be arranged in at least one row such as a first or upper row 61a and a second or lower row 61b that is spaced from the upper row 61a along the transverse direction T, so as to define a gap 63 that extends along the transverse direction T between the upper row 61a and the lower row 61b. Each of the upper and lower rows 61a and 61b extends along a row direction 51, which can be defined as the lateral direction A in accordance with the illustrated embodiment. Accordingly, the electrical contacts 38 of each row are spaced from each other along the lateral direction A. The front end 33a of the housing body 33, and in particular the opposed top and bottom ends 33e and 33f, and the opposed first and second sides 33c and 33d at the front end 33a, can define a receptacle 106 that extends into the front end 33a so as to at least partially define the mating interface 26. The receptacle 106 is configured to receive a portion, such as a front or leading edge 202a of the substrate 200 (see FIG. 3) when the electrical connector 22 is are mated to the substrate, such that the gap 63 receives a mating interface 205 of the substrate 200, that includes the leading edge 202a, thereby placing the plurality of electrical contacts 38 in electrical communication with the electrical contact pads 204 that are carried by the substrate body 202 at the mating interface 205 in accordance with the illustrated embodiment. Thus, the electrical connector 22 can be referred to as an edge-card connector. Further, because the electrical connector 22 is configured to receive the substrate 200 so as to mate the electrical connector 22 with the substrate 200, the electrical connector 22 can be referred to as a receptacle connector in accordance with the illustrated embodiment. Furthermore, it should be appreciated that the mating ends 39 of the electrical contacts 38 are configured to straddle opposed top and bottom sides of the substrate 200 when the electrical connector 22 is mated with the substrate 200.

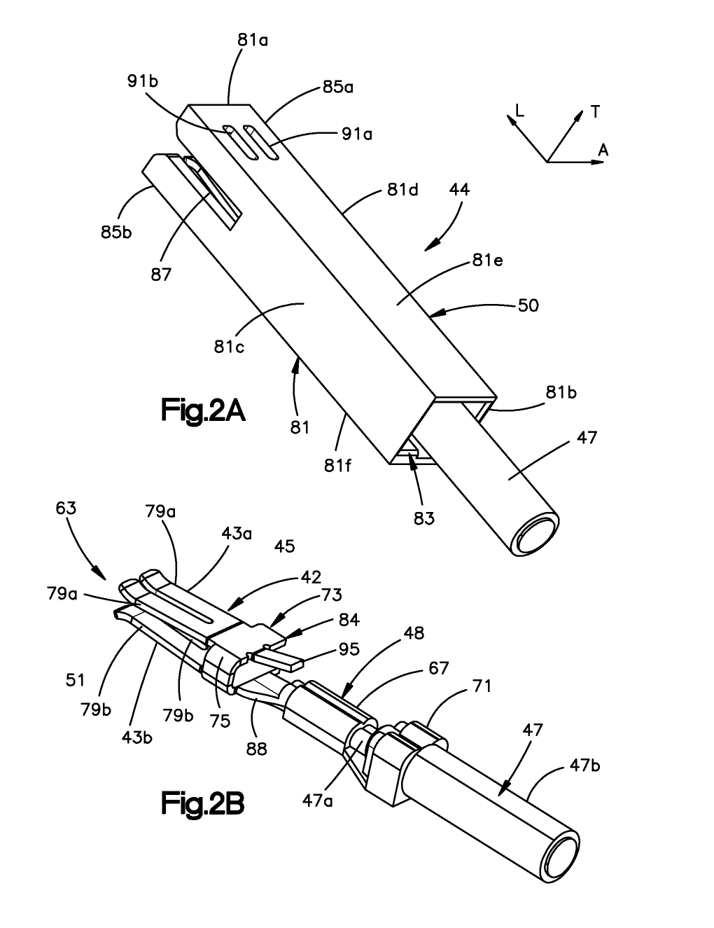

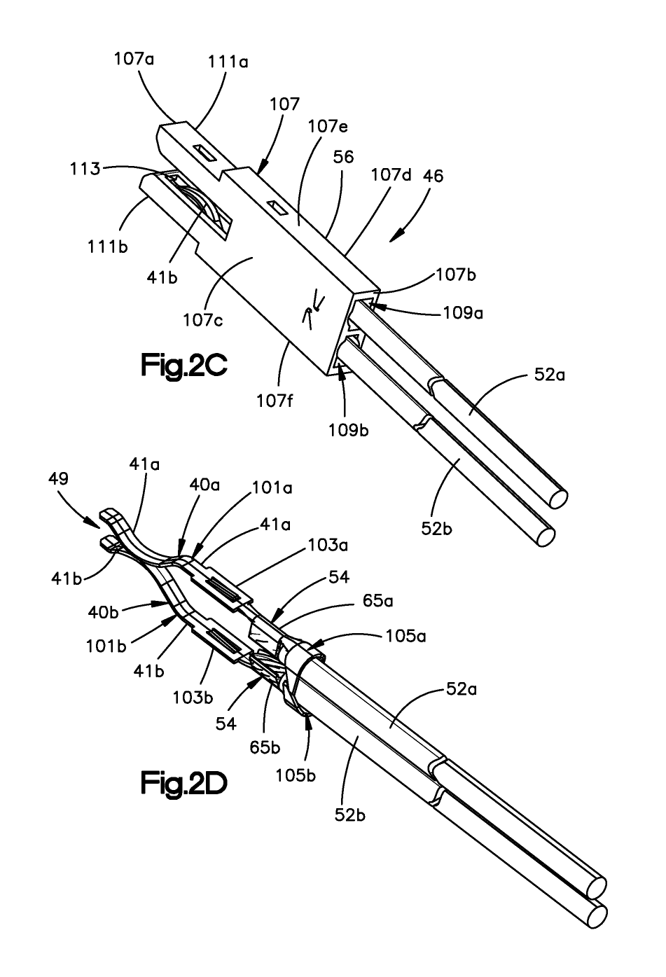

Referring now to FIGS. 1A-2D, each of the plurality of electrical contacts 38 defines a mounting end that is configured to be attached to the first complementary electrical device. For instance, each of the electrical signal contacts 40 defines a mounting end 65 that is configured to be mounted to at least one complementary signal cable 52 so as to define a corresponding plurality of signal contact assemblies 46. Furthermore, each of the electrical power contacts 42 defines a mounting end 67 that is configured to be mounted to at least one complementary power cable 47 so as to define a corresponding plurality of power contact assemblies 44. In accordance with the illustrated embodiment, the mating ends 39 of the plurality of electrical contacts 38 are disposed proximate to the mating interface 26, and thus proximate to the front end 33a of the housing body 33. Further, in accordance with the illustrated embodiment, the mounting ends of the plurality of electrical contacts 38 are disposed proximate to the mounting interface 31, and thus proximate to the rear end 33b of the housing body. Accordingly, the mating ends 39 are oriented substantially parallel to the mounting ends of the plurality of electrical contacts 38, and the plurality of electrical contacts 38 can be referred to as vertical electrical contacts. It should be appreciated, however, that the plurality of electrical contacts 38 can be configured as right-angle electrical contacts whereby the mating ends 39 of the plurality of electrical contacts 38 are oriented substantially perpendicular to each other. For instance, the mating ends 39, and thus the mating interface 26, can be disposed proximate the front end 33a of the housing body 33, and the mounting ends of the plurality of electrical contacts 38, and thus the mounting interface 31, can be disposed proximate the bottom end 33f of the housing body 33.

Referring now to FIGS. 2A-B in particular, each power contact assembly 44 can include a power cable 47 and at least one electrical power contact 42 that is crimped or otherwise attached to the power cable 47 at an interface 48 between each respective mounting end 67 and a complementary one of the power cables 47, so as to place the electrical power contact 42 and the power cable 47 in electrical communication. For instance, each power cable 47 includes an electrically conductive portion, such as an electrically conductive wire 47a, and an electrically insulative portion, such as an electrically insulative sheath 47b, that surrounds the wire 47a. The mounting ends 67 of the electrical power contacts 42 can be crimped about the wire 47a of the complementary power cable 47 so as to place the power cable 47 in electrical communication with the corresponding electrical power contact 42. Each electrical power contact 42 can further include a strain relief member 71 that is disposed rearward of the mounting end 67, and can be attached to the complementary power cable. For instance, the strain relief member 71 can be crimped about the sheath 47b, such that a majority of a rearwardly directed tensile force applied to the power cable 47 at a location rearward of the strain relief member 71 is absorbed at an interface between the strain relief member and the sheath 47b. Thus, the majority of the rearwardly directed tensile force is isolated from the interface 48 between the mounting end 67 and the wire 47a.

The electrical power contacts 42 can each include a contact body 84 that defines a mating end 45, the mounting end 67 that includes at least one first or upper beam 43a and at least one second or lower beam 43b, a lead portion 73 that is connected between the mating end 45 and the mounting end 67, and the strain relief member 71. In accordance with the illustrated embodiment, the mating end 45, the mounting end 67, the lead portion 73, and the strain relief member 71 are integral and monolithic with each other. The lower beam 43b is spaced from the upper beam 43a along the transverse direction T, such that the upper beam 43a is disposed in the upper row 61a and the lower beam 43b is disposed in the lower row 61b (see FIG. 1B), and the gap 63 is disposed between the upper and lower beams 43a and 43b. The lead portion 73 can include a strap 75 that is attached between the upper and lower beams 43a and 43b so as to support the upper and lower beams 43a and 43b in the respective upper and lower rows 61a and 61b. The lead portion 73 can further include a neck 88 that extends from the mounting end 67 to the strap 75, for instance at a location substantially aligned with the lower beam 43b, such that the strap extends from the strap 75 and attaches to both the lower beam 43b and the upper beam 43a.

Each of the upper and lower beams 43a and 43b can be cantilevered from the lead portion 73, and in particular from the strap 75. At least a first portion, such as a rear portion, of the upper beams 43a can extend toward the lower beams 43b, and a second portion, such as a front portion, of the upper beams 43a can extend away from the lower beams 43b. Similarly, at least a first portion, such as a rear portion, of the lower beams 43b can extend toward the upper beams 43a, and a second portion, such as a rear portion, of the lower beams 43b can extend away from the upper beams 43a. The front end of the upper and lower beams 43a and 43b can be split as desired such that each of the upper and lower beams 43a and 43b defines first and second fingers 79a and 79b, respectively, that are spaced from each other along the row direction 51.

Each power contact assembly 44 can include an electrically insulative power contact retainer 50 that supports the power cable 47 and the electrical power contact 42. For instance, the power contact retainer 50 can include a body 81 that defines a front end 81a and an opposed rear end 81b that is spaced from the front end 81a along the longitudinal direction L, first and second opposed sides 81c and 81d that are spaced from each other along the lateral direction A, and a top end 81e and an opposed bottom end 81f that is spaced from the top end 81e along the transverse direction T. The power contact retainer 50 can be supported by the connector housing 30 such that the front end 81a is disposed proximate to the mating interface 26 of the electrical connector 22, and the rear end 81b is disposed proximate to the mounting interface 31 of the electrical connector 22.

The power contact retainer 50 can define an opening 83 that extends forward through the rear end 81b of the body 81 along the longitudinal direction L toward the front end 50a. The power contact retainer 50 further includes upper and lower opposed retainer arms 85a and 85b that extend forward from the body 81, for instance from the front end 81a, along the longitudinal direction L. Each of the upper and lower retainer arms 85a and 85b can define a surface that faces the other of the upper and lower retainer arms 85a and 85b, and defines a pocket 87 that extends into the surface along the transverse direction T, such that at least a first portion of the respective upper and lower beams 43a and 43b is at least partially disposed in the respective pockets 87, and a second portion of the respective upper and lower beams 43a and 43b protrudes from the respective surface toward the opposed ones of the upper and lower retainer arms 85a and 85b.

The power contact retainer 50 can further define at least one heat dissipation window that can extend through at least one such as both of the upper and lower retainer arms 85a and 85b along the transverse direction T, and can be aligned with the respective electrical power contact 42, for instance at the mating end 45. In accordance with the illustrated embodiment, the power contact retainer 50 defines first and second heat dissipation windows 91a and 91b that extends through each of the upper and lower retainer arms 85a and 85b along the transverse direction T in at least partial alignment, such as alignment, with the first and second fingers 79a and 79b, respectively. For instance, the first and second heat dissipation windows 91a and 91b that extend through the upper retainer arm 85a can be aligned with the first and second fingers 79a and 79b of the upper beam 43a, and the first and second heat dissipation windows 91a and 91b that extend through the lower retainer arm 85b can be aligned with the first and second fingers 79a and 79b of the lower beam 43b. The first and second heat dissipation windows 91a and 91b that extend through the upper and lower retainer arms 85a and 85b can further be aligned with respective first and second heat dissipation windows 93a and 93b that extend through the housing body 33 of the connector housing 30 (see FIG. 1B), and can extend for instance through the top and bottom ends 33e and 33f of the housing body 33 along the transverse direction T. Accordingly, during operation, heat disposed at the mating ends 45 of the electrical power contacts 42 can travel through the first and second heat dissipation windows 91a and 91b, and further through the first and second heat dissipation windows 93a and 93b, respectively, and out the connector housing 30.

Accordance with the illustrated embodiment, the electrical power contacts 42 and power cables 47 can be inserted into the power contact retainer 50 after the mounting end 67 has been attached to the power cable 47. For instance, with continuing reference to FIGS. 2A-B, each of the electrical power contacts 42 can include at least one retention flange 95 that resiliently extends from the contact body 84 rearward along the longitudinal direction L and up along the transverse direction T. For instance, the retention flange 95 can extend from the strap 75, and is configured to mate with a complementary recess disposed in the body 81 of the power contact retainer 50 as the electrical power contacts 42 are inserted forward along the longitudinal direction L through the opening 83 of the rear end 81b of the body 81 until the mating end 45 is disposed in the respective pocket 87, and the complementary power cable 47 extends rearward along the longitudinal direction L out the opening 83. Alternatively, the electrical power contacts 42 can be overmolded by the respective power contact retainers 50. The power contact assemblies 44 can then be installed in the connector housing 30 by securing the power contact retainers 50 in the housing body 33.

Referring now to FIGS. 2C-D, each signal contact assembly 46 can include at least one signal cable 52 and a corresponding at least one electrical signal contact 40 that is crimped or otherwise secured to the at least one signal cable 52 at an interface 54, so as to place at least one electrical signal contact 40 and the signal cable 52 in electrical communication. Each signal contact assembly 46 can further include a signal contact retainer 56 that supports the at least one signal cable 52 and the corresponding at least one electrical signal contact 40. In accordance with the illustrated embodiment, the signal contact assembly 46 includes a first or upper signal cable 52a and a second or lower signal cable 52b that is spaced from the upper signal cable 52a along the transverse direction T, and a corresponding first or upper electrical signal contact 40a and a second or lower electrical signal contact 40b that is spaced from the upper electrical signal contact 40a along the transverse direction T. The upper electrical signal contact 40a is configured to be mounted to the upper signal cable 52a, and the lower electrical signal contact 40b is configured to be mounted to the lower signal cable 52b. Unless otherwise indicated, reference to the electrical signal contacts 40 and the signal cables 52, and components thereof, refers to both the upper and lower electrical signal contacts 40a and 40b, and the upper and lower signal cables 52a and 52b, and components thereof, respectively.

In accordance with the illustrated embodiment, each of the upper electrical signal contacts 40a can include a respective upper contact body 101a that defines an upper mating end 41a, an upper mounting end 65a, and an upper lead portion 103a that extends between the upper mounting end 65a and the upper mating end 41a. Each of the upper electrical signal contacts 40a can further include an upper strain relief member 105a that extends rearward from the upper mounting end 65a along the longitudinal direction L. Similarly, each of the lower electrical signal contacts 40b can include a respective lower contact body 101b that defines a lower mating end 41b, a lower mounting end 65b, and a lower lead portion 103b that extends between the lower mounting end 65b and the lower mating end 41b. Each of the lower electrical signal contacts 40b can further include lower strain relief member 105b that extends rearward from the lower mounting end 65b along the longitudinal direction L. In accordance with the illustrated embodiment, the upper and lower mating ends 41a-b, the upper and lower mounting ends 65a-b, lead portion 73, and the strain relief member 105 are integral and monolithic with each other.

Each signal cable 52 includes an electrically conductive portion, such as an electrically conductive wire 53a, and an electrically insulative portion, such as an electrically insulative sheath 53b, that surrounds the wire 53a. The mounting ends 65 of the electrical signal contacts 40 can be crimped about the wire 53a of the complementary signal cable 52 so as to place the wire 53a in electrical communication with the respective electrical signal contact 40. The strain relief member 105 can be attached to the complementary signal cable 52. For instance, the strain relief member 105 can be crimped about the sheath 53b, such that a majority of a rearwardly directed tensile force applied to the signal cable 52 at a location rearward of the strain relief member 105 is absorbed at an interface between the strain relief member 105 and the sheath 53b. Thus, the majority of the rearwardly directed tensile force is isolated from the interface 54 between the mounting end 65 and the wire 53a.

The upper electrical signal contacts 40a are spaced from the lower electrical signal contacts 40b along the transverse direction T, such that the upper electrical signal contact 40a is disposed in the upper row 61a and the lower electrical signal contact 40b is disposed in the lower row 61b (see FIG. 1B), and the gap 63 is disposed between the upper and lower electrical signal contacts 40a and 40b.

Each of the mating ends 41 can be cantilevered from the lead portion 103, such that at least a first portion, such as a rear portion, of the upper mating ends 41a can extend toward the lower mating ends 41b, and a second portion, such as a front portion, of the upper mating ends 41a can extend away from the lower mating ends 41b. Similarly, at least a first portion, such as a rear portion, of the lower mating ends 41b can extend toward the upper mating ends 41a, and a second portion, such as a rear portion, of the lower mating ends 41b can extend away from the upper mating ends 41a.

Each signal contact assembly 46 can include an electrically insulative signal contact retainer 56 that supports one of the upper signal cables 52a and one of the lower signal cables 52b that is aligned with the one of the upper signal cables 52a along the transverse direction T. For instance, the signal contact retainer 56 can include a body 107 that defines a front end 107a and an opposed rear end 107b that is rearwardly spaced from the front end 107a along the longitudinal direction L, first and second opposed sides 107c and 107d that are spaced from each other along the lateral direction A, and a top end 107e and an opposed bottom end 107f that is downwardly spaced from the top end 107e along the transverse direction T. The signal contact retainer 56 can be supported by the connector housing 30 such that the front end 107a is disposed proximate to the mating interface 26 of the electrical connector 22, and the rear end 107b is disposed proximate to the mounting interface 31 of the electrical connector 22.

The signal contact retainer 56 can define at least one opening that extends forward through the rear end 107b of the body 81 along the longitudinal direction L toward the front end 50a. For instance, the signal contact retainer 56 can define an upper opening 109a and a lower opening 109b that is spaced from the upper opening 109a along the transverse direction. The signal contact retainer 56 further includes upper and lower opposed retainer arms 111a and 111b that extend forward from the body 107, for instance from the front end 107a, along the longitudinal direction L. Each of the upper and lower retainer arms 111a and 111b can define a surface that faces the other of the upper and lower retainer arms 111a and 111b, and defines a pocket 113 that extends into the surface along the transverse direction T, such that at least a first portion of the respective upper and lower mating ends 41a and 41b is at least partially disposed in the respective pockets 113, and a second portion of the respective upper and lower mating ends 41a and 41b protrudes from the respective surface toward the opposed ones of the upper and lower retainer arms 111a and 111b.

Accordance with the illustrated embodiment, the electrical power contacts 42 and power cables 47 can be inserted into the power contact retainer 50 after the mounting end 67 has been attached to the power cable 47. Alternatively, the electrical power contacts 42 can be overmolded by the respective power contact retainers 50. The power contact assemblies 44 can then be installed in the connector housing 30 by securing the power contact retainers 50 in the housing body 33. It should be further appreciated that the mating ends 39 of the plurality of electrical contacts 38 can include either or both of the mating ends 45 of the electrical power contacts 42 and the mating ends 41 of the electrical signal contacts 40, and that the mounting ends of the plurality of electrical contacts 38 can include either or both of the mounting ends 67 of the electrical power contacts 42 and the mounting ends 65 of the plurality of electrical signal contacts 40.

It should be appreciated that the power cables 47 and the signal cables 52 can have different gauges or diameters. For instance, the power cables 47 can each define a first diameter and the signal cables 52 can each define a second diameter that is less than the first diameter. Accordingly, the mounting interface 31 of the electrical connector 22 is configured to receive, and mount to, the power cables 47 that define the first diameter and the signal cables 52 that define the second diameter. Similarly, the mounting ends of the electrical signal contacts 40 and the mounting ends of the electrical power contacts 42 are configured to be attached to the power cables 47 that define the first diameter and the signal cables 52 that define the second diameter.

Referring now to FIG. 3, the substrate 200 can be configured as a printed circuit board. The substrate 200 includes a substrate body 202 that defines a front or leading edge 202a an opposed rear or trailing edge 202b that is spaced from the leading edge 202a along the longitudinal direction L, a first side edge 202c and an opposed second side edge 202d that is spaced from the first side edge 202c along the lateral direction A, and a top surface 202e and an opposed bottom surface 202f that is spaced from the top surface 202e along the transverse direction T. The first and second side edges 202c and 202d are connected between the leading edge 202a and the trailing edge 202b, and the opposed top and bottom surfaces 202e-f extend between the leading and trailing edges 202a-b and the first and second side edges 202c-d. The leading and trailing edges 202a-b and the first and second side edges 202c-d define an outer perimeter of the substrate body 202. The opposed top and bottom surfaces 202e-f can be substantially planar along respective planes defined by the longitudinal and lateral directions L and A, respectively. The leading and trailing edges 202a-b extend along the lateral direction A between the first and second side edges 202c and 202d when the leading edge 202a is received by the receptacle 106 of the electrical connector 22 so as to mate the electrical connector 22 with the substrate 200. The first and second side edges 202c and 202d extend along the longitudinal direction L between the leading and trailing edges 202a-b when the leading edge 202a is received by the receptacle 106 of the electrical connector 22.

At least one, such as a plurality of the electrical contact pads 204 can be carried by at least one or both of the top and bottom surfaces 202e and 202f, such that the electrical contact pads 204 are disposed at the mating interface 205, and arranged substantially parallel to the leading edge 202a at a location proximate to the leading edge 202a at the projection region 203. Accordingly, when a complementary electrical component, for instance the electrical connector 22, is mated to the substrate 200, the mating ends of electrical contacts of the electrical connector abut the mating interface 205, and in particular the electrical contact pads 204, thereby placing the substrate 200 into electrical communication with the electrical contacts 38 of the electrical connector 22.

The electrical contact pads 204 can include at least one electrical power contact pad 206 such as a plurality of electrical power contact pads 206 and at least one electrical signal contact pad 208 such as a plurality of electrical signal contact pads 208 that extend along the mating interface 205. The plurality of electrical power contact pads 206 and the plurality of electrical signal contact pads 208 can be carried by each of the top and bottom surfaces 202e and 202f of the substrate body 202, and can be spaced from each other along the lateral direction A. While the illustrated embodiment includes nine electrical power contact pads 206 and six electrical signal contact pads 208, carried by each of the top and bottom surfaces 202e and 202f of the substrate body 202, it should be appreciated that the substrate 200 is not limited to the illustrated arrangement and number of electrical contact pads 204, and that the substrate 200 can alternatively be constructed with any number of electrical power contact pads 206 and/or electrical signal contact pads 208, in any arrangement as desired. In accordance with alternative embodiments, the substrate 200 can be devoid of electrical signal contact pads 208, such that the plurality of electrical contact pads 204 includes only electrical power contact pads 206. Alternatively still, the substrate 200 can be devoid of electrical power contact pads 206, such that the plurality of electrical contact pads 204 includes only electrical signal contact pads 208.

The substrate body 202 can define a thickness between the top and bottom surfaces 202e-f along the transverse direction T that is substantially equal or slightly greater than a distance between the upper and lower retainer arms 85a and 85b of the power contact retainer 50 (see FIGS. 2A-B). Further, the thickness of the substrate body 202 can be substantially equal to or slightly greater than a distance between the upper and lower retainer arms 111a and 111b of the signal contact retainer 56 (see FIGS. 2C-D). Accordingly, when the substrate 200 is inserted into the housing body 33 of the electrical connector, the mating interface 205 of the substrate 200 is received between the upper and lower retainer arms 85a and 85b, and between the upper and lower retainer arms 111a and 111b, which can deflect to provide a normal force against the electrical power contact pads 206 and the electrical signal contact pads 208. Thus, the electrical signal contact pads 208 contact the upper and lower mating ends 41a and 41b of the electrical signal contacts 40, thereby placing the electrical signal contacts 40 in electrical communication with the electrical signal contact pads 208, and the electrical power contact pads 206 contact the mating ends 45 of the electrical power contacts 42, thereby placing the electrical power contacts 42 in electrical communication with the electrical power contact pads 206.

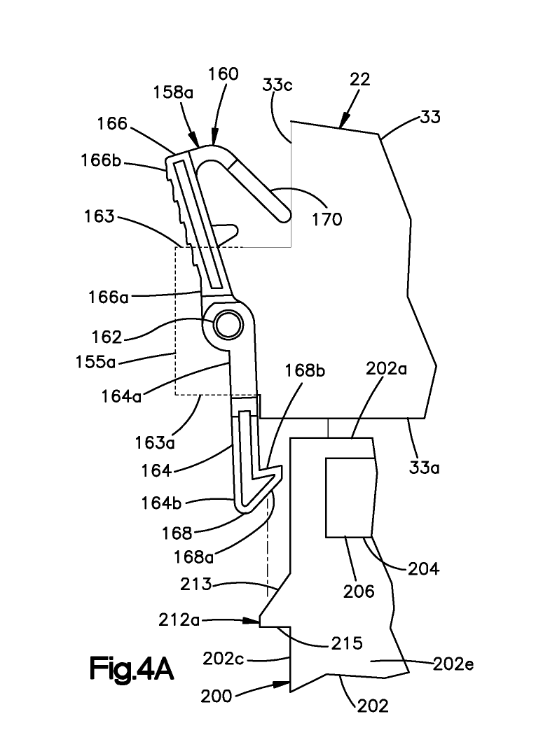

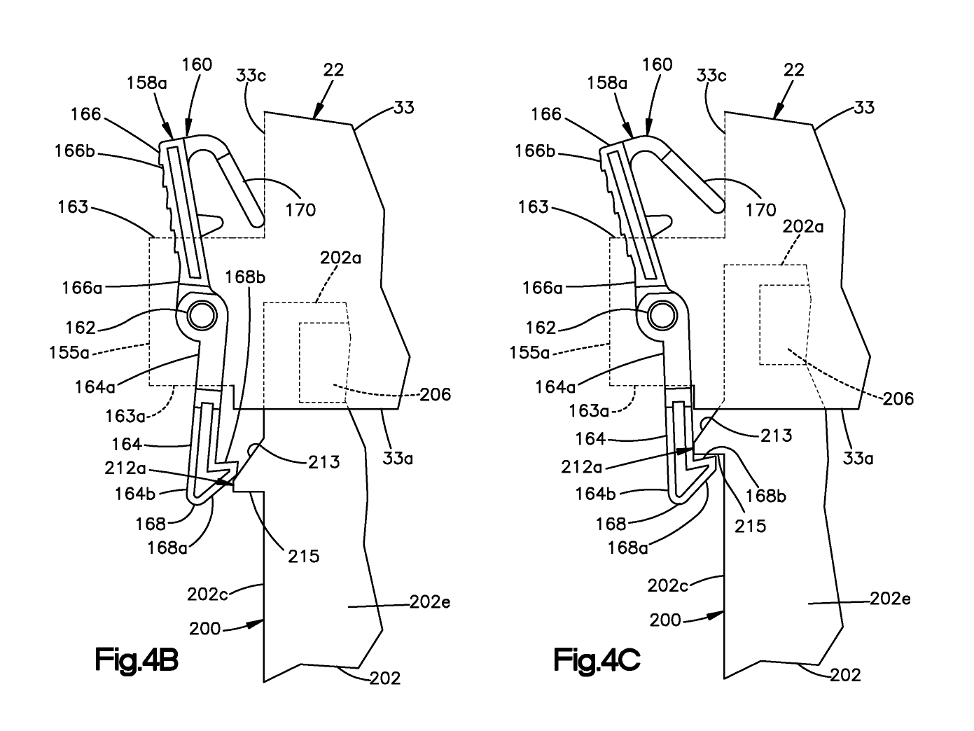

Referring now to FIGS. 1A-B and FIGS. 3A-4C, and as described above, the electrical connector assembly 20 can include an attachment assembly 74 that includes at least on attachment member, such as the first and second attachment members 154a-b of the electrical connector 22, and at least one attachment member, such as the first and second attachment members 211a-b of the substrate 200. Each of the first and second attachment members 211a-b is configured to releasably engage with a respective complementary one of the first and second attachment members 154a-b of the electrical connector 22, which are described in more detail below. In accordance with the illustrated embodiment, the first and second attachment members 211a-b are configured as first and second projections 212a and 212b, respectively, that extend out along the lateral direction A from the first and second side edges 202c and 202d, respectively. Each of the first and second attachment members 211a-b can further extend along the transverse direction T from the top surface 202e to the bottom surface 202f. The first and second projections 212a-b are not aligned with any of the electrical contact pads 204 along the longitudinal direction L. Thus, the first and second projections 212a-b are not aligned along the longitudinal direction L with a region of the substrate body 202 that 1) is defined by and between the outermost ones of the electrical contact pads 204 with respect to the lateral direction A, and 2) extends from the leading edge 202a to the trailing edge 202b.

Each of the first and second projections 212a-b defines a respective leading engagement surface 213 and a respective trailing engagement surface 215. The leading engagement surfaces 213 can be beveled, and can thus extend outward from the respective first and second side edges 202c-d along the lateral direction A as they extend rearward along the longitudinal direction L. The trailing engagement surfaces 215 can extend inward toward, for instance to, the substrate body 202 along the lateral direction A from the leading engagement surfaces 213. Thus, the trailing engagement surfaces 215 can be disposed rearward with respect to the leading engagement surfaces 213 along the longitudinal direction L.

Referring now to FIGS. 1A-B and FIGS. 4A-C, the electrical connector 22 can include at attachment member such as a first attachment member 154a and a second attachment member 154b that are pivotally supported by the connector housing 30 and configured to releasably secure the electrical connector 22 to a complementary electrical component, such as the substrate 200. In accordance with the illustrated embodiment, the connector housing 30 includes at least one support member such as a first support member 155a and a second support member 155b that are supported by the housing body 33, for instance by the respective first and second sides 33c and 33d of the housing body 33. The connector housing 30 defines at least one pocket, such that the at least one attachment member is at least partially disposed in the at least one pocket. For instance, the connector housing 30, defines a first pocket 156a and a second pocket 156b, such that the first and second attachment members 154a and 154b can be pivotally supported by the first and second support members 155a and 155b and at least partially reside in the respective first and second pockets 156a and 156b. Thus, the first and second attachment members 154a and 154b are pivotally supported relative to the housing body 33, and it should be further appreciated that the first and second attachment members 154a and 154b can be directly pivotally attached to the housing body 33 as desired.

In accordance with the illustrated embodiment, the first and second pockets 156a and 156b extend at least into or through the first and second first and second support members 155a and 155b along the longitudinal direction L. All of the plurality of electrical contacts 38 can be disposed between the first and second support members 155a and 155b.

Each of the first and second support members 155a and 155b can include a respective base 157 that can define a bottom boundary of the respective first and second pockets 156a-b, and a top wall 161 that is spaced from the base 157 upward along the transverse direction T and can define a top boundary of the respective first and second pockets 156a-b. The top wall 161 can be parallel to the base 157. Each of the first and second support members 155a and 155b can further include at least one side wall 159 that extends from the respective base 157, for instance up along the transverse direction T to the top wall 161. The top wall 161 can be coplanar or parallel with the top end 33e of the housing body 33, and the base 157 can be coplanar or parallel with the bottom end 33f of the housing body 33. The side walls 159 can be spaced outward from the respective first and second sides 33c and 33d of the housing body 33 along the lateral direction A, such that the base 157 and the top wall 161 extend between the housing body 33 and the side wall 159 along the lateral direction A. Thus, each of the side walls 159 can define an outer side boundary of the first and second pocket 156a-b, respectively, with respect to the lateral direction A. The first and second pockets 156a-b can each further define an open front end 163a that is open to the front end 33a of the housing body 33, and an open rear end 165 that is spaced from the open top end 163a along the longitudinal direction L.

In accordance with the illustrated embodiment, the at least one attachment member of the electrical connector 22 can be configured as at least one latch member. For instance, each of the first and second attachment members 154a-b can be configured as first and second latch members 158a-b, respectively, that can be constructed identical to each other, though it should be appreciated that the first and second attachment members 154a-b can be alternatively constructed as desired. Each of the first and second latch members 158a-b includes a latch body 160 and a pivot member 162 that is carried by the latch body 160. The latch body 160 further includes a latch arm 164 that extends substantially forward from the pivot member 162 along the longitudinal direction L, and a handle member 166 that extends substantially rearward from the pivot member 162 along the longitudinal direction L.

The pivot member 162 can be integral and monolithic with the latch body 160, or can be separate from and attached to the latch body 160. For instance, the pivot member 162 can be configured as a pin that extends through the latch body 160. The handle member 166 can define a textured grip surface that facilitates ergonomic engagement by opposed thumbs or fingers of a user when actuating the first and second latch members 158a-b as described in more detail below. The pivot members 162 can extend out from the latch body 160 along the lateral direction A into apertures 112 that extend into one or both of the base 157 and the top wall 161. Thus, the first and second latch members 158a-b can be at least partially disposed in the respective first and second pockets 156a-b. The pivot members 162 are rotatable in the respective apertures 112 about a pivot axis P that extends along the transverse direction T, such that the latch body 160 can pivot about the pivot axis P as the first and second latch members 158a-b pivot, and thus move, between respective attachment positions and detachment positions. For instance, the latch members 158a-b can pivot about the respective pivot axis P in respective attachment directions from respective detachment positions to respective attachment directions, and in respective detachment directions from respective attachment positions to respective detachment directions.

The pivot axes P can be disposed at respective locations that are spaced rearward from the front end 33a of the housing body 33. Furthermore, the pivot axis P of the first latch member 158a can be aligned with the pivot axis P of the second latch member 158b along the lateral direction A. The illustrated pivot members 162 are substantially cylindrically shaped, but any other suitable pivot member geometry can be used as desired.

As is described in more detail below, each of the first and second latch members 158a-b, and in particular each latch body 160, is pivotable about the pivot member 162, and thus is pivotable about the respective pivot axis P, in 1) a first attachment direction which is configured to attach the respective first and second latch members 158a-b to the respective first and second attachment members 211a-b of the substrate 200, and 2) a second detachment direction that is opposite the attachment direction, which is configured to detach the respective first and second latch members 158a-b from the respective first and second attachment members 211a-b of the substrate 200. It should be appreciated that the pivot axis P can extend along the transverse direction T, and thus perpendicular to the mating direction M (see FIG. 1B).

The latch arm 164 extends forward from the pivot member 162 along the longitudinal direction L, and defines an inner end 164a that is disposed proximate to the pivot member 162 and an opposed outer end 164b that can extend forward from the inner end 164a along the longitudinal direction L, and thus extend forward from the pivot member 162 along the longitudinal direction L. The outer end 164b can further be spaced from the inner end 164a along the mating direction M, and can extend forward from the front end 33a of the housing body 33. Each latch body 160 of the first and second latch members 158a-b can include a lock member such as a barb 168 that is configured to releasably engage with an engagement member of a complementary electrical component, for instance the respective first and second projections 212a-b of the substrate 200, so as to attach the connector housing 30 to the substrate 200. The barb 168 is thus spaced from the front end 33a of the housing body 33 along the mating direction.

The barbs 168 can be shaped as desired, and can extend inward from the outer end 164b of the respective latch arms 164 along the lateral direction A (and thus toward the electrical contacts 38), and defines a leading engagement surface 168a that can be beveled in along the lateral direction as it extends rearward in the longitudinal direction L from the outer end 164b. The leading engagement surfaces 168a are configured to be aligned with the leading engagement surfaces 213 of the substrate 200 along the longitudinal direction L when the electrical connector 22 is aligned with the substrate 200 to mate with the substrate 200. Accordingly, the leading engagement surfaces 168a are configured to abut and cam outward along the lateral direction A over the leading engagement surfaces 2123 of the substrate 200 as the electrical connector 22 is mated with the substrate 200, such that the barbs 168 ride along the respective projections 212a-b as the electrical connector is mated with the substrate 200. The barb 168 further defines a trailing engagement surface 168b that is opposite the leading engagement surface 168a and rearwardly spaced from the leading engagement surface 168b along the longitudinal direction L. The trailing engagement surface 168b is further angularly offset with respect to the leading engagement surface 168a. Thus, the leading engagement surface 168a is spaced from the trailing engagement surface 168b in the mating direction M.

The handle member 166 extends rearward from the pivot member 162 along the longitudinal direction L, and defines an inner end 166a that is disposed proximate to the pivot member 162, and an opposed outer end 166b that can extend rearward from the inner end 166a along the longitudinal direction L, and thus extend rearward from the pivot member 162 along the longitudinal direction L. Each of the first and second latch members 158a-b can include a resilient spring member 170 that extends from the latch body 160, for instance from handle member 166, such as from the outer end 166b of the handle member 166 toward the housing body 33, for instance toward the base respective one of the first and second sides 33c and 33d. Thus, the pivot location 162 is disposed between the barb 168 and the spring member 170. The spring member 170 can be configured as a resilient and flexible arm having a portion that is spaced from the handle member 166, for instance inwardly spaced from the handle member 166 along the lateral direction A. The spring members 70 are configured to abut and resiliently compress against the housing body 33, for instance at the respective one of the first and second sides 33c and 33d, as the latch body 160 pivots in the detachment direction about the pivot axis P, which causes the handle member 166 to move in a first direction, such as inward along the lateral direction A and thus toward the electrical contacts 68, and causes the latch arm 164 and thus the barb 168 to move in an opposed second direction, such as up outward along the lateral direction A, and thus away from the electrical contacts 68. It should be appreciated that when the spring member 170 is compressed against the housing body 33, the spring member 170 applies a biasing force to the handle member 166 that biases the handle member 166 to travel in the second direction, which thereby biases the latch body 160 to pivot about the pivot axis P in the attachment direction, latch arm 164 and thus the barb 168 travel in the first direction.

During operation, when the electrical connector 22 is mated to the substrate 200, the mating interface 26 of the electrical connector is aligned with the mating interface 205 of the substrate 200 such that the relative movement between the electrical connector 22 and the substrate 200 along the mating direction M causes the leading edge 202a of the substrate body 202 to be inserted into the receptacle 106. As the mating interfaces 26 and 205 are coupled to each other, the mating ends of the electrical contacts 38, of each of the upper and lower rows 61a and 61b, respectively, abut the complementary electrical contact pads 204 that are carried by at least one or both of the top and bottom surfaces 202e and 202f of the substrate 200. For instance, the mating ends of the electrical signal contacts 40 can abut the complementary electrical signal contact pads 208 that are carried by one or both of the top and bottom surfaces 202e and 202f, thereby placing the substrate 200 in electrical communication with the electrical connector 22. Similarly, the mating end of the electrical power contacts 42 can abut the complementary electrical power contact pads 206 that are carried by the one or both of the top and bottom surfaces 202e and 202f.

When the electrical connector 22 is aligned with the substrate 200 for mating, the leading engagement surfaces 168a of the first and second latch members 158a-b can be aligned with the complementary leading engagement surfaces 213 of the first and second projections 212a-b with respect to the mating direction M when the latch members 158a-b are in a first or initial position. As the electrical connector 22 is thus mated with the substrate 200 such that the receptacle 106 receives the substrate 200, the leading engagement surfaces 168a can cam over the leading engagement surfaces 213 of the first and second respective projections 212a-b as described above. It should be appreciated that as the leading engagement surfaces 168a, and thus the arm members 164, move outward along the lateral direction A as they cam over the complementary leading edges 213 of the substrate 200, the latch arms 164 pivot along the detachment direction, which causes the spring members 170 to compress against the housing body 33. The compression of the spring members 170 against the housing body 33 causes the spring members 170 to apply a biasing force against the handle members 166 that biases the latch bodies 160 to pivot about the pivot axis P in the attachment direction. However, mechanical interference between the projections 212a-b and the barbs 168 prevents the latch bodies 160 from pivoting in the attachment direction. The barbs 168 continue to ride along leading engagement surfaces 213 until the substrate 200 is fully received in the receptacle 106, such that the mating ends 39 of the electrical contacts 38 contact the electrical contact pads 204 of the substrate 200 in the manner described above. When the substrate 200 is fully received in the receptacle 106, the trailing engagement surfaces 168b of the latch members 158a-b moves past the respective trailing engagement surfaces 215 of the substrate 200, such that the trailing engagement surfaces 168b are spaced along the longitudinal direction L from the trailing engagement surfaces 215 of the substrate 200. Accordingly, each of the trailing engagement surfaces 215 is disposed between the respective one of the trailing engagement surfaces 168b and the respective one of the leading engagement surfaces 213.

Next, the biasing force of the spring members 170 drives the latch bodies 160 to pivot about the pivot axis P in the attachment direction, which causes the barbs 168, and thus the trailing engagement surfaces 168b, to move inward along the lateral direction A toward the substrate 200 such that the trailing engagement surfaces 168b are aligned with the respective trailing engagement surfaces 215 along the longitudinal direction L. As a result, a line extending in the longitudinal direction L can pass through both the respective trailing engagement surfaces 215 and the aligned one of the trailing engagement surfaces 168b. Because the trailing engagement surfaces 168b and 215 are aligned with each other, mechanical interference between the trailing engagement surfaces 168b and the respective trailing engagement surfaces 215 limit or prevent movement of the substrate 200 away from the electrical connector 22 along the longitudinal direction L opposite the mating direction. Thus, engagement between the first and second attachment members 154a-b of the electrical connector 22 and the first and second attachment members 211a-b of the substrate 200 secures the substrate 200 to the electrical connector 22 after the electrical connector 22 has been mated to the substrate 200.

In accordance with an alternative embodiment, when the electrical connector 22 is aligned with the substrate 200 for mating, a user can apply an inward force against the handle members 166 along the lateral direction A against the biasing force of the spring members 170, which causes the first and second latch members 158a-b to move, such as pivot, in the detachment direction from the first position toward the detachment position, whereby the leading engagement surfaces 168a, and an entirety of the barbs 168, are removed from alignment with the substrate body 202. For instance, the entirety of the barbs 168 can be spaced out from the substrate 200 along the lateral direction A, such that the electrical connector 22 can mate with the substrate 200 until the substrate 200 is fully received in the receptacle 106, such that the mating ends 39 of the electrical contacts 38 contact the electrical contact pads 204 of the substrate 200 in the manner described above, without bringing the barbs 168 into contact with the complementary projections 212a-b. As the first and second latch members 158a-b move in the detachment direction, the spring members 170 compress against the housing body 33, thereby biasing the first and second latch members 158a-b to move in the attachment direction. Accordingly, when the substrate 200 is fully received in the receptacle 106, the barbs 168 become aligned with the complementary first and second projections 212a-b, respectively. The applied force can be removed from the handle members 166, which causes the biasing force of the spring members 170 to actuate the first and second latch members to move in the attachment direction to the respective attachment positions, whereby the trailing engagement surfaces 168b, and thus the barbs 168, move inward along the lateral direction into alignment with the respective trailing engagement surfaces 215, and thus the projections 212a-b, in the manner described above.

When it is desired to unmate the substrate 200 from the electrical connector 22, the first and second latch members 158a-b can be actuated to displace the barbs 168 outward from the respective first and second projections 212a-b along the lateral direction A. For instance, the handle members 166 can be depressed inward along the lateral direction A into the toward the housing body 33, for instance toward the respective first and second sides 33c-d against the biasing force of the spring member 170, which causes the causing the latch bodies 160 to pivot about the respective pivot axes P in the detachment direction, such that the respective latch arms 164, and thus the barbs 168, move up outward the lateral direction A out of alignment with the respective first and second projections 212a-b, thereby removing the mechanical interference between the trailing engagement surfaces 168b and the engagement surfaces 215. The substrate 200 can then be disengaged from the electrical connector 22 by moving one or both of the substrate 200 and the electrical connector 22 away from the other along a direction opposite the mating direction M.

It should be appreciated that when the latch members 158a-b are in their respective first or initial positions, at least a portion, for instance at least the outer end 166b, of the handle members 166 are outwardly spaced from the housing body 33, for instance from the respective first and second sides 33c-d, along the lateral direction A. In accordance with one embodiment, each of the first and second latch members 158a-b can be actuated to their respective detachment positions, whereby the handle members 166 can be depressed until the outer ends 166b are at least substantially flush with, or disposed inward of or outward of, the respective first and second sides 33c-d of the housing body 33, which causes the barbs 168 to be removed from alignment with the respective first and second projections 212a-b as described above. It should be appreciated, however, that the first and second latch members 158a-b can be constructed as desired, so as to adjust the amount of movement of the handle members 166 that causes the barbs 168 to be removed from alignment with the respective first and second projections 212a-b.

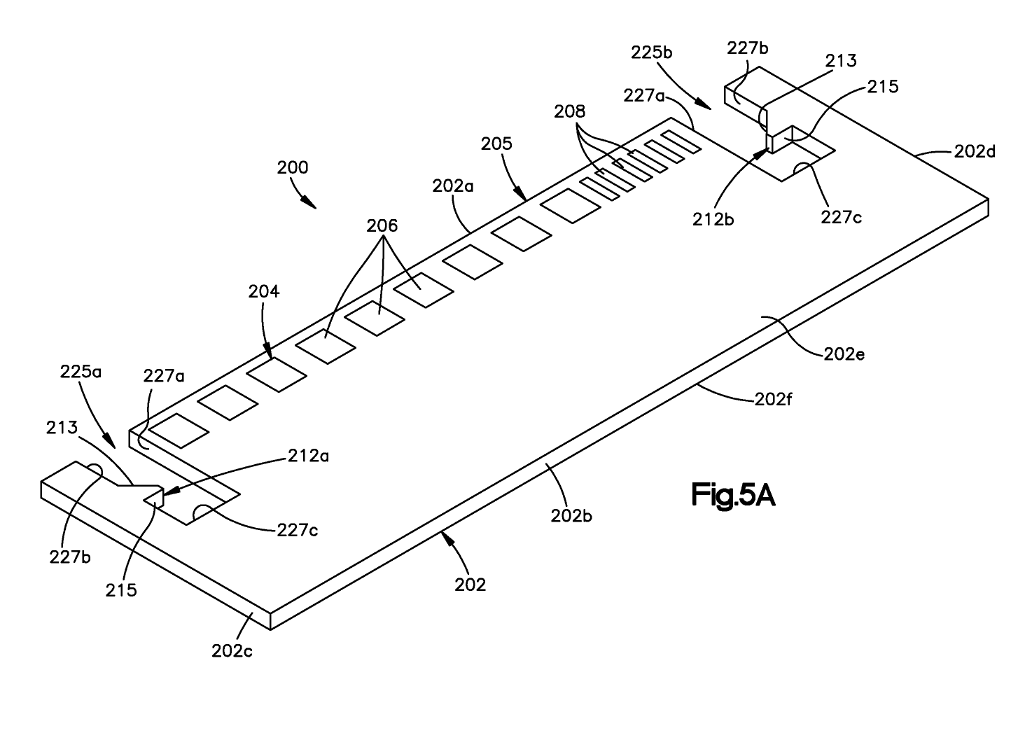

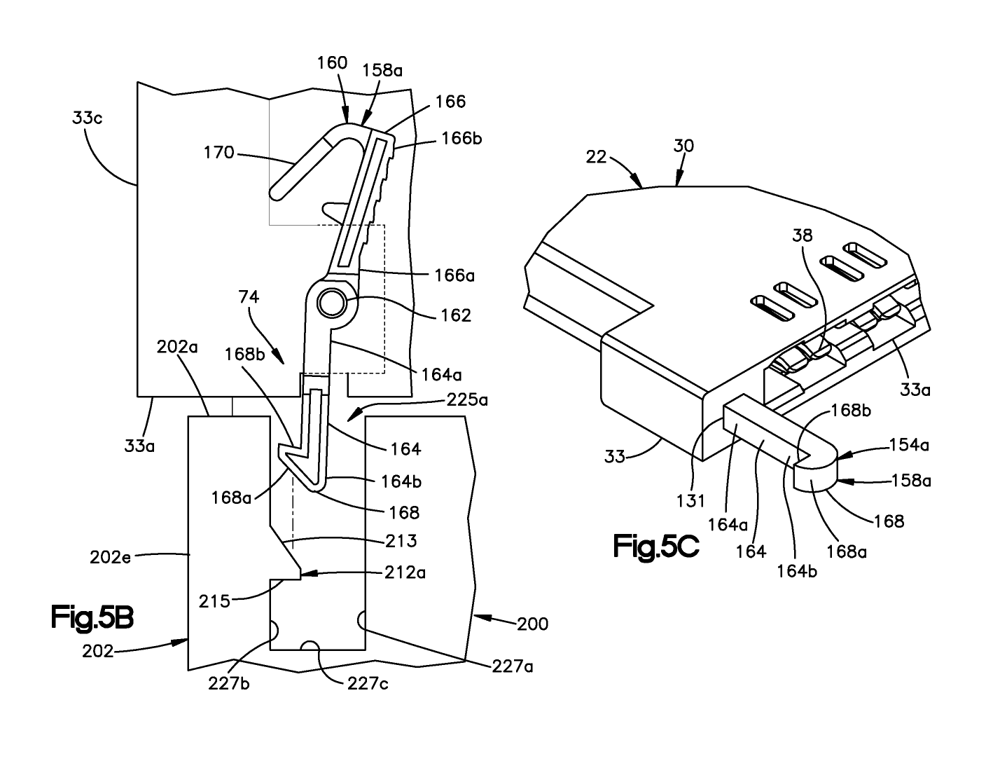

While the latch assembly 74 has been described in accordance with one embodiment, it should be appreciated that the latch assembly 74 can be constructed in accordance with alternative embodiments. For instance, referring to FIGS. 5A-B, the first and second projections 212a-b can be disposed between the first and second side edges 202c and 202d along the lateral direction A. It should be appreciated that the first and second side edges 202c and 202d define outermost side edges of the substrate 200. In accordance with one embodiment, the substrate 200 can include first and second slots 225a-b that extend into the leading edge 202a of the substrate body 202 along the longitudinal direction L at locations adjacent to and inwardly spaced from the first and second side edges 202c and 202d, respectively. The substrate body 202 thus defines at least one inner interior surface and at least one outer interior surface, such as a pair of inner interior surfaces 227a and a pair of outer interior surfaces 227b that are spaced from the respective inner surfaces 227a along the lateral direction A so as to define inner and outer boundaries of the first and second slots 225a-b, respectively. The substrate body 202 can further define at least one interior base, such as a pair of interior bases 227c that extend between the respective inner and outer surfaces 227a-b so as to define a rear boundary of the first and second slots 225a-b, respectively. The inner and outer 227a-b can be disposed between the first and second side edges 202c and 202d along the lateral direction A, and each base 227c can be disposed rearward from the leading edge 202a of the substrate body 202. Further, the inner and outer surfaces 227a-b can extend between the leading edge 202a and the respective base 227c along the longitudinal direction L, and each base 227c can extend between the respective inner and outer surfaces 227a-b along the lateral direction A. Thus, the inner and outer surfaces 227a-b define side surfaces that partially define the first and second slots 225a-b, respectively, and the bases 227 define an end surface that partially defines the first and second slots 225a-b, respectively. All of the plurality of electrical contact pads 204 can extend between the first and second slots 225a-b along the lateral direction A.

The first and second projections 212a-b can extend from the substrate body 203, for instance from either of the inner and outer surfaces 227a and 227b along the lateral direction A into the respective slots 225a-b. For example, the first and second projections 212a-b can extend inward from the outer surfaces 227b along the lateral direction A into the respective slots 225a-b. Further, the latch members can be oriented such that the barbs 168 extend outward from the outer end 164b of the respective latch arms 164 along the lateral direction A (and thus away from the electrical contacts 38). Additionally, the spring members 170 can abut an interior surface 229 of the housing body 33 that is inwardly spaced with respect to the first and second side edges 202c-d along the lateral direction A.

Thus, as the latch bodies 130, and thus the latch members 158a-b pivot in the attachment direction, the latch arms 164 move outward along the lateral direction A away from the electrical contacts 38, and the handle members 166 move inward along the lateral direction A toward the electrical contacts 38. Conversely, as the latch bodies 130, and thus the latch members 158a-b pivot in the detachment direction, the latch arms 164 move inward along the lateral direction A toward from the electrical contacts 38, and the handle members 166 move outward along the lateral direction A away from the electrical contacts 38.

Accordingly, when the electrical connector 22 is aligned with the substrate 200 for mating, the leading engagement surfaces 168a of the first and second latch members 158a-b can be aligned with the complementary leading engagement surfaces 213 of the first and second projections 212a-b with respect to the mating direction M when the latch members 158a-b are in a first or initial position. As the electrical connector 22 is thus mated with the substrate 200 such that the receptacle 106 receives the substrate 200, the leading engagement surfaces 168a can cam inward along the lateral direction A over the leading engagement surfaces 213 of the first and second respective projections 212a-b in the respective slots 225a-b. It should be appreciated that as the leading engagement surfaces 168a, and thus the arm members 164, move inward along the lateral direction A as they cam over the complementary leading edges 213 of the substrate 200, the latch arms 164 pivot along the detachment direction, which causes the spring members 170 to compress against the housing body 33. The compression of the spring members 170 against the housing body 33 causes the spring members 170 to apply a biasing force against the handle members 166 that biases the latch bodies 160 to pivot about the pivot axis P in the attachment direction. However, mechanical interference between the projections 212a-b and the barbs 168 prevents the latch bodies 160 from pivoting in the attachment direction. The barbs 168 continue to ride along leading engagement surfaces 213 until the substrate 200 is fully received in the receptacle 106, such that the mating ends 39 of the electrical contacts 38 contact the electrical contact pads 204 of the substrate 200 in the manner described above. When the substrate 200 is fully received in the receptacle 106, the trailing engagement surfaces 168b of the latch members 158a-b moves past the respective trailing engagement surfaces 215 of the substrate 200, such that the trailing engagement surfaces 168b are spaced along the longitudinal direction L from the trailing engagement surfaces 215 of the substrate 200. Accordingly, each of the trailing engagement surfaces 215 is disposed between the respective one of the trailing engagement surfaces 168b and the respective one of the leading engagement surfaces 213.

Next, the biasing force of the spring members 170 drives the latch bodies 160 to pivot about the pivot axis P in the attachment direction, which causes the barbs 168, and thus the trailing engagement surfaces 168b, to move outward along the lateral direction A such that the trailing engagement surfaces 168b are aligned with the respective trailing engagement surfaces 215 along the longitudinal direction L. As a result, a line extending in the longitudinal direction L can pass through both the respective trailing engagement surfaces 215 and the aligned one of the trailing engagement surfaces 168b. Because the trailing engagement surfaces 168b and 215 are aligned with each other, mechanical interference between the trailing engagement surfaces 168b and the respective trailing engagement surfaces 215 limit or prevent movement of the substrate 200 away from the electrical connector 22 along the longitudinal direction L opposite the mating direction. Thus, engagement between the first and second attachment members 154a-b of the electrical connector 22 and the first and second attachment members 211a-b of the substrate 200 secures the substrate 200 to the electrical connector 22 after the electrical connector 22 has been mated to the substrate 200.

While the latch members 158a-b are illustrated as pivotally attached to the connector housing 30, it should be appreciated that the latch members 158a-b can be supported by the connector housing 30 in accordance with alternative embodiments as desired. For instance, the latch members 158a-b can be rigidly attached to the connector housing 30 at an attachment location 131, and the latch arms 164 extend from the attachment location 131, as illustrated in FIG. 5C. For instance, the latch members 158a-b can be integral and monolithic with the connector housing 30 at the attachment location 131, and the latch arms 164 can be cantilevered from the attachment location 131. The latch arms 164 can be resilient and flexible so as to define respective spring members, such that as the barbs 168 cam over the respective first and second projections 212a-b, the latch arms 164 resiliently flex and deflect along a first lateral direction A, for instance inwardly or outwardly depending on the direction of extension of the respective first and second projections 212a-b until the trailing engagement surfaces 168b of the latch members 158a-b move past the respective trailing engagement surfaces 215 of the substrate 200, such that the trailing engagement surfaces 168b are spaced along the longitudinal direction L from the trailing engagement surfaces 215 of the substrate 200. Next, the biasing force of the deflected resilient latch arms 164 can drive the barbs 168, and thus the trailing engagement surfaces 168b, to move along a second lateral direction A that is opposite the first lateral direction toward the surface from which the projections 212a-b extend, such that the trailing engagement surfaces 168b are aligned with the respective trailing engagement surfaces 215 along the longitudinal direction L, thereby securing the electrical connector 22 to the substrate 200 as described above.

The embodiments described in connection with the illustrated embodiments have been presented by way of illustration, and the present invention is therefore not intended to be limited to the disclosed embodiments. Furthermore, the structure and features of each the embodiments described above can be applied to the other embodiments described herein, unless otherwise indicated. Accordingly, those skilled in the art will realize that the invention is intended to encompass all modifications and alternative arrangements included within the spirit and scope of the invention, for instance as set forth by the appended claims.

What is claimed:

1. An electrical cable connector configured to be mated to a substrate along a mating direction, the electrical connector comprising:
a connector housing defining a housing body that has a front end that defines a mating interface, the connector housing further defining a receptacle that extends into the front end so as to at least partially define the mating interface, the receptacle sized to receive a front edge of the substrate;
a plurality of electrical contacts carried by the connector housing, the electrical contacts defining mating ends that are configured to electrically connect to electrical contact pads carried by at least one of top and bottom surfaces of the substrate when the mating interface receives the substrate, the electrical contacts defining mounting ends that are disposed opposite the mating ends and are configured to electrically connect to respective cables; and
at least one latch member supported by the connector housing the at least one latch member including 1) a latch body that includes a latch arm that extends forward from the front end of the housing body, and a lock member that extends from the latch arm and is spaced forward from the front end of the housing body along the mating direction, the lock member defining a leading engagement surface and a trailing engagement surface, and 2) a spring member;
wherein the leading engagement surface is configured to be aligned with a leading engagement surface of an attachment member of the substrate as the electrical connector is mated to the substrate, such that the leading engagement surface of the lock member is configured to move in a perpendicular to the mating direction against a biasing force of the spring member until the trailing engagement surface moves past a trailing engagement surface of the attachment member of the substrate, such that the biasing force of the spring member drives the latch body to move in an attachment direction so as to bring the trailing engagement surfaces into alignment with respect to the mating direction.

2. The electrical cable connector as recited in claim 1, wherein the at least one latch member further includes a handle and a pivot member disposed between the latch arm and the handle, wherein the pivot member is pivotally mounted to the housing body about a pivot axis that is substantially perpendicular to the mating direction, such that the latch member is pivotable about the pivot axis in the attachment direction and a detachment direction that is opposite the attachment direction.

3. The electrical cable connector as recited in claim 2, wherein the electrical contacts are arranged in first and second rows that are spaced apart along a transverse direction that is substantially perpendicular to the mating direction, and the electrical contacts of each row are spaced from each other along a lateral direction that is substantially perpendicular to the transverse direction and the mating direction, and the pivot axis extends along the transverse direction.

4. The electrical cable connector as recited in claim 3, wherein depressing the handle toward the plurality of electrical contacts along the lateral direction causes the at least one latch member to pivot about the pivot axis in the detachment direction.

5. The electrical cable connector as recited in claim 3, wherein the housing body defines first and second outermost sides, such that all of the plurality of electrical contacts are disposed between the first and second outermost sides, and the spring member compresses against one of the first and second outermost sides the base as the latch member pivots in the detachment direction, the spring member biasing the at least one latch member to pivot in the attachment direction.

6. The electrical cable connector as recited in claim 5, wherein the at least one latch member is a first latch member, the electrical connector further comprising a second latch member that includes a latch arm that carries a lock member, a handle, and a pivot member disposed between the latch arm and the handle of the second latch member, and a spring member that extends from the handle of the second latch member, wherein the pivot member of the second latch member is pivotally mounted to the housing body about a second pivot axis that is substantially perpendicular to the mating direction, such that the second latch member is pivotable about the pivot axis in an attachment direction and an opposed detachment direction,
wherein the lock member of the second latch member defines a leading engagement surface and a trailing engagement surface, and the leading engagement surface of the second latch member is configured to be aligned with a leading engagement surface of a second attachment member of the substrate as the electrical connector is mated to the substrate, such that the second latch member pivots about the second pivot axis so as to move the engagement surface of the lock member of the second latch member is configured to move in a first direction substantially perpendicular to the mating direction against a biasing force of the spring member until the trailing engagement surface of the second latch member moves past a trailing engagement surface of the second attachment member of the substrate, and the biasing force of the spring member of the second latch member drives the lock member of the second latch member to move in a second direction opposite the first direction so as to bring the trailing engagement surface of the second latch member into alignment with the trailing engagement surface of the second attachment member of the substrate respect to the mating direction.

7. The electrical cable connector as recited in claim 6, wherein all of the plurality of electrical contacts are disposed between the first and second latch members.

8. The electrical cable connector as recited in claim 2, wherein the pivot axis is spaced rearward from the front end of the connector housing in a direction opposite the mating direction.

9. The electrical cable connector as recited in claim 8, wherein the latch arm defines an inner end that is disposed proximate to the pivot member, and an outer end that is spaced in the mating direction from the inner end, and the lock member extends from the outer end of the latch arm.

10. The electrical cable connector as recited in claim 9, wherein the leading engagement surface of the lock member is beveled.

11. The electrical cable connector as recited in claim 10, wherein the trailing engagement surface is angularly offset with respect to the leading engagement surface.

12. The electrical cable connector as recited in claim 1, wherein the electrical contacts comprises a plurality of electrical power contacts and a plurality of electrical signal contacts.

13. The electrical cable connector as recited in claim 12, wherein the electrical power contacts are configured to be mounted to a respective plurality of electrical power cables, and the electrical signal contacts are configured to be mounted to a respective plurality of electrical signal cables.

14. The electrical cable connector as recited in claim 13, wherein the electrical power contacts are configured to mount to the plurality of power cables that each define a first diameter, the electrical signal contacts are configured to mount to the plurality of electrical cables that each define a second diameter, and the second diameter is less than the first diameter.

15. The electrical cable connector as recited in claim 1, wherein the mating ends of the electrical contacts are configured to straddle the substrate when the electrical connector is mated with the substrate.

16. The electrical cable connector as recited in claim 1, wherein the latch arm and lock member move along a direction toward the electrical contacts as the leading engagement surface of the lock member cams over the leading engagement surface of the attachment member of the substrate.

17. The electrical cable connector as recited in claim 16, wherein the latch body is pivotally attached to the connector housing.

18. The electrical cable connector as recited in claim 16, wherein the latch body is rigidly attached to the connector housing at an attachment location, such that the latch arm is cantilevered from the attachment location.

19. The electrical cable connector as recited in claim 18, wherein the latch body is monolithic with the connector housing.

20. The electrical cable connector as recited in claim 18, wherein at least one latch member is a first latch member, the electrical cable connector further comprising a second latch member supported by the connector housing the second latch member including 1) a latch body that includes a latch arm that extends forward from the front end of the housing body such, and a lock member that extends from the latch arm and is spaced forward from the front end of the housing body along the mating direction, the lock member defining a leading engagement surface and a trailing engagement surface, and 2) a spring member;
wherein the leading engagement surface of the second latch member is configured to be aligned with a second leading engagement surface of an attachment member of the substrate as the electrical connector is mated to the substrate, such that the leading engagement surface of the second latch member is configured to move in a perpendicular to the mating direction against a biasing force of the spring member of the second latch member until the trailing engagement surface of the second latch member moves past a trailing engagement surface of the second attachment member of the substrate, such that the biasing force of the spring member of the second latch member drives the latch body of the second latch member to move in an attachment direction so as to bring the trailing engagement surface of the second latch member into alignment with the trailing engagement surface of the second attachment member of the substrate with respect to the mating direction.

21. The electrical cable connector as recited in claim 20, wherein the latch body of the second latch member is rigidly attached to the connector housing at a second attachment location, such that the latch arm of the second latch member is cantilevered from the second attachment location.

22. The electrical cable connector as recited in claim 21, wherein the latch body of the second latch member is monolithic with the connector housing.
